(19) United States
(12) Patent Application Publication
(10) Pub. No.: US 2019/0269948 A1
(43) Pub. Date: Sep. 5, 2019

(54) SUSPENSION RELIEF SEAT AS AN INTERMEDIATE ARTICLE OF MANUFACTURE

(71) Applicant: Sherry Green Mullins, Jasper, GA (US)

(72) Inventor: Sherry Green Mullins, Jasper, GA (US)

(21) Appl. No.: 16/243,762

(22) Filed: Jan. 9, 2019

Related U.S. Application Data
(60) Provisional application No. 62/615,102, filed on Jan. 9, 2018.

(51) Int. Cl. A62B 35/00

(52) U.S. Cl. CPC A62B 35/0012; A62B 35/0025; A62B 35/0018

(57) ABSTRACT

A suspension relief seat that can be attached to a support harness for securing a person to an anchor point.

### FIELD OF THE INVENTION

This invention relates to a suspension relief seat for attachment to a safety harness, the safety harness can be used for securing a person to an anchor point.

### BACKGROUND OF THE INVENTION

In a typical hunting or in some work environments, safety harnesses must be utilized when the user is hunting or working from an elevated position. A conventional safety harness is secured about the user's body in a way to secure the user in the harness which is then attached to connection point on a Tree (in hunting) or a safety cage (in a work environment). The purpose of the safety harness is to prevent the user from hitting the ground. Without the harness, a fall to the ground could cause serious injury or death.

Conventional safety harnesses are comprised of a series of straps which are secured about the torso, shoulders, waist and legs. There are two leg straps. One strap is secured around the top of the legs, across the groin area (and femoral artery) and connect to other end of leg strap and/or back up to the waist strap. This series of straps has another strap of varying length (determined by the manufacturer) typically called a “tether”. The “Tether” is attached to the safety harness at the back of the harness at a location at or about the area between the shoulder blades at center of user's back and base of neck. It is attached either permanently or by use of a carabiner. The other end of the Tether typically has a carabiner which is used to connect to a fixed object at the elevated position capable of holding the user's body weight such as the tree (in hunting) or a safety cage in a work environment in case of a fall. The tether is of varying lengths typically determined by the manufacturer. If the tether is too short, the user cannot move enough to hunt or work.

In a Conventional safety harness, should the user experience a fall from the elevated position, the user is suspended in the harness hanging from the tether attached to the fixed object at the connection point at the elevated position. In this situation, the user's body weight is being pressed against the lowest point in the safety harness which is typically the leg straps. In a typical conventional harness, the leg straps are positioned across the groin area and femoral artery. So, the strap has all the force imposed by the user's body weight pressed against the femoral artery. If a user remains in that suspended position for a prolonged period of time, the user can die. The user's body weight is a significant factor in how long the user can remain suspended before it becomes fatal. The heavier the user, the higher the risk of dying in this position.

In a fall situation in a conventional harness, the user is typically rendered in a position below their elevated hunting or working platform. They may or may not be able to climb back up to the elevated position to safety and disconnect (self-extract). The user may have to rely on being rescued. Their physical location may or may not be known to others. Hanging in this position below the elevated platform for a prolonged period of time IS A LIFE THREATENING SITUATION.

### SUMMARY OF THE INVENTION

The Suspension Relief Seat provides LIFE SAVING BENEFITS in a fall situation.

The Suspension Relief Seat provides the transfer of body weight from the leg straps to the Suspension Relief Seat. In a fall situation with the Suspension Relief Seat utilized as a feature in a Conventional Safety Harness, the user would be RENDERED IN A SEATED POSITION WITH THEIR BODY WEIGHT TRANSFERRED TO THE SUSPENSION RELIEF SEAT INSTEAD OF ONTO THE LEG STRAPS.

The resulting position is likened unto sitting on a PLAYGROUND SWING. It may get a little uncomfortable. But, it is not life threatening. The Suspension Relief Seat provides for maneuverability in a way that the user can shift their weight around to different pressure points until they are rescued or self-extract.

The Suspension Relief Seat is a unique mechanical feature which may be added to any conventional harness design in the process of manufacturing the harness. This Suspension Relief Seat Feature provide for the transfer of the user's body weight from the leg straps to the Suspension Relief Seat.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 shows the suspension relief seat attached to a support harness being used/worn by a person shown in dashed lines.

FIG. 2 is a perspective view of the suspension relief seat not attached to a harness.

FIG. 3 is a side view of the suspension relief seat showing the layers that make up the suspension relief seat.

FIG. 4 is an exploded view taken from FIG. 2.

FIG. 5 is a rear view of the suspension relief seat showing optional pouches.

FIG. 6 is a right side view of the suspension relief seat showing the attachment buckle.

FIG. 7 is a left side view of the suspension relief seat showing the attachment buckle.

FIG. 8 is a perspective view of the suspension relief seat and the attachment buckles before being attached.

FIG. 9 is a perspective view of the suspension relief seat attached to a harness.

FIG. 9A shows a close up of the attachment buckle of FIG. 9.

FIG. 10 is a second perspective view of the suspension relief seat attached to a harness. FIG. 10A shows a close up of the attachment buckle of FIG. 10.

FIG. 11 is a perspective view of the SRS showing openings for leg straps.

FIG. 12 is a side view of the SRS showing openings for leg straps.

### DETAILED DESCRIPTION OF THE INVENTION

The Suspension Relief Seat provides LIFE SAVING BENEFITS in a fall situation.

The Suspension Relief Seat provides the transfer of body weight from the leg straps to the Suspension Relief Seat. In a fall situation with the Suspension Relief Seat utilized as a feature in a Conventional Safety Harness, the user would be RENDERED IN A SEATED POSITION WITH THEIR BODY WEIGHT TRANSFERRED TO THE SUSPENSION RELIEF SEAT INSTEAD OF ONTO THE LEG STRAPS.

The resulting position is likened unto sitting on a PLAYGROUND SWING. It may get a little uncomfortable. But, it is not life threatening. The Suspension Relief Seat provides for maneuverability in a way that the user can shift their weight around to different pressure points until they are rescued or self-extract.

The Suspension Relief Seat is a unique mechanical feature which may be added to any conventional harness design in the process of manufacturing the harness. This Suspension Relief Seat Feature provide for the transfer of the user's body weight from the leg straps to the Suspension Relief Seat.

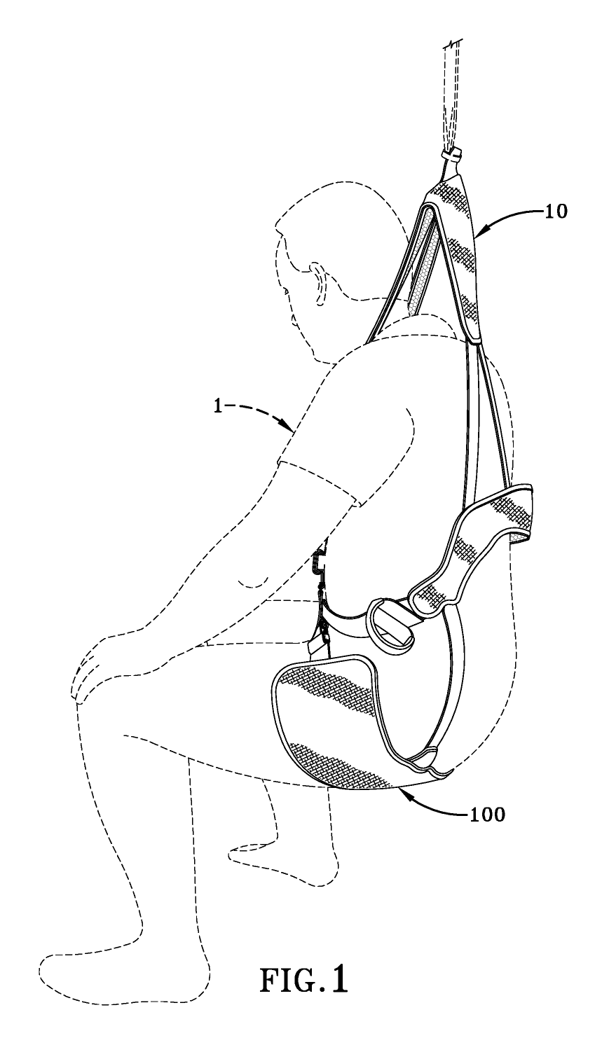

The Suspension Relief Seat 100 shown in FIG. 1 is attached to the support harness 10 worn by a user 1.

The SUSPENSION RELIEF SEAT (SRS) 100 is made up of layers of material with the inside layer 101 being the layer which may be attached to each side of any conventional support harness is a weight/load bearing material.

The finished width of the inside material creates an area with wide enough surface area to accommodate a user sitting on it comfortably without putting stress on circulation (LIKENED UNTO SITTING ON A PLAYGROUND SWING).

The material making up the SRS 100 may be comprised of one width of a length of strap, webbing or rope material (2.5″ to 24″+ in width) or may be made up of a combination of several widths of narrow strap, webbing or rope material of appropriate weight bearing capacity configured or joined together in a way to create a width of 2.5″ to 24″+.

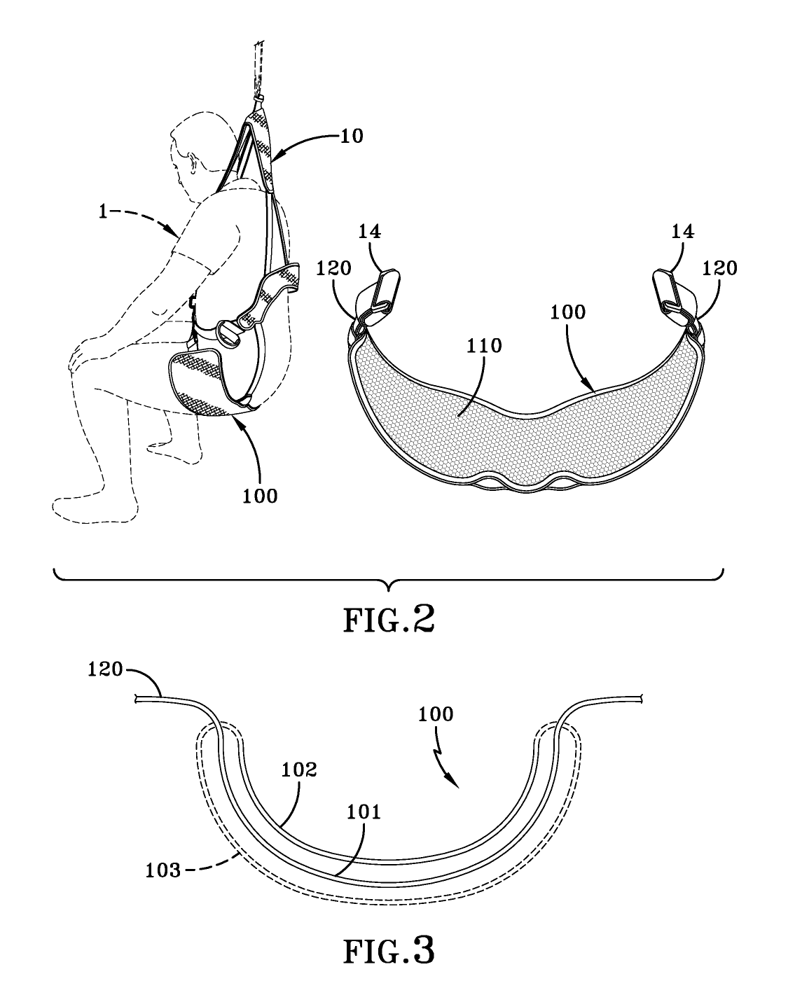

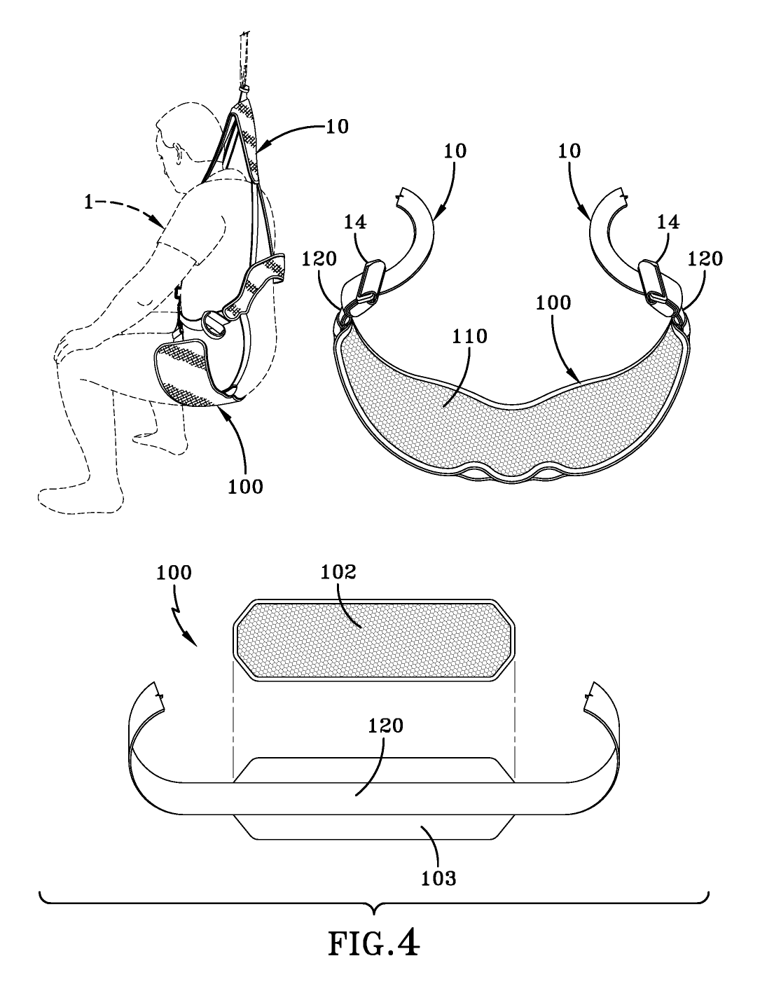

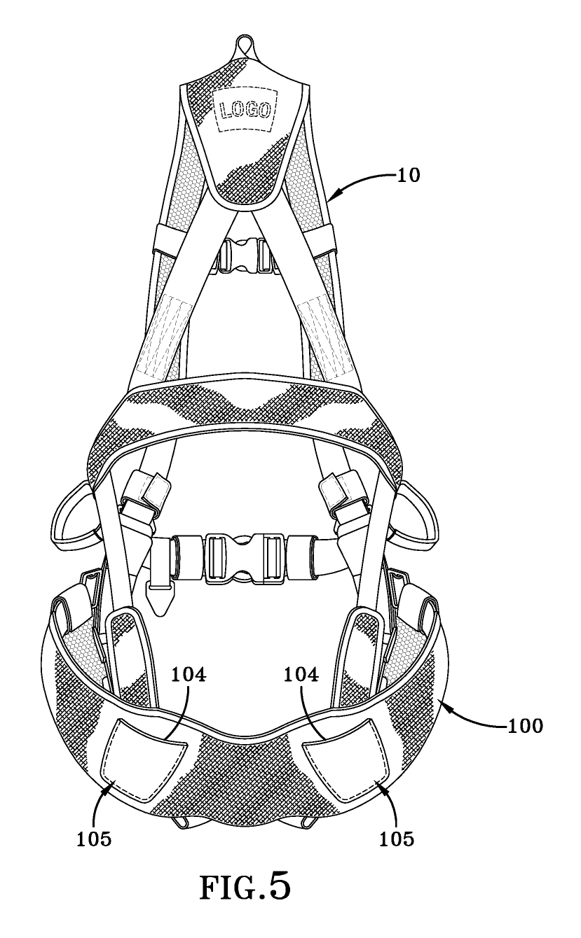

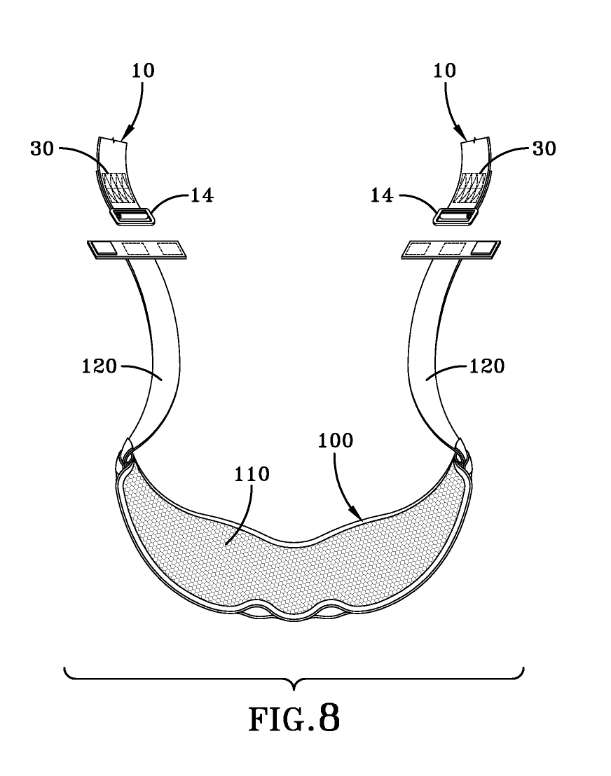

The length of the seat area 110 (which may be 6″ to 36″ or more inches, shown in FIGS. 2, 3) which should be wide enough to comfortably lay across the backside of the user at or about the bottom of buttocks from one side of hips to the other side of hips (position of Seat shown in FIG. 8) and is reduced down to a more narrow length of strap 120, webbing or rope material which can be threaded through an adjuster buckle 14.

The material making up the SRS 100 may have an outer layer 102 in another material for comfort.

The material making up the SRS may have a third layer for aesthetics 103.

The material making up the SRS 100 may have a fourth layer 104 which may be utilized to create storage pockets or pouches 105.

The width of the SRS 100 when in use (see FIG. 1) accommodates comfort and maneuverability in such a way to allow the user 1 to reposition on the SRS 100. This is important in the event a user cannot self-extract safely and must stay seated for a prolonged period of time while awaiting assistance.

THE SRS provides for adjustability for comfort while in normal use and/or in the event of a deployed situation.

The SUSPENSION RELIEF SEAT provides LIFE SAVING POTENTIAL: if a user falls in a harness, the user would be rendered in a seated position

THE Suspension Relief Seat 100 renders the user 1 in a seated position (See FIG. 1) which avoids putting pressure on the femoral artery in the legs which is typical of conventional safety or support harnesses. This provides life-saving potential.

With the appropriate configured harness 10, leg straps may be loosened once the user 1 is seated in the SRS 100 and body weight is completely transferred to the Suspension Relief Seat 100 with NO weight placed on the leg straps.

The suspension relief seat 100 may be added to any harness 10 in several different ways, some of which are: sewn onto the shoulder strap at a specific location on the shoulder strap to render the desired position when deployed such that the SUSPENSION RELIEF SEAT (SRS) strap, webbing or rope material become like a continuation of the shoulder straps like a “playground swing”.

The suspension Relief Seat 100 may be sewn into the bottom of the shoulder strap of a conventional harness in such a way to allow the length of strap, webbing or rope material (2.5″ to 24″+ in width) to be adjusted to fit properly to the user once the harness is donned. In this configuration, the length of strap, webbing or rope material (2.5″ to 24″+ in width) may be threaded through a weight bearing adjuster buckle which provides a high-test breaking strength AND adjustability

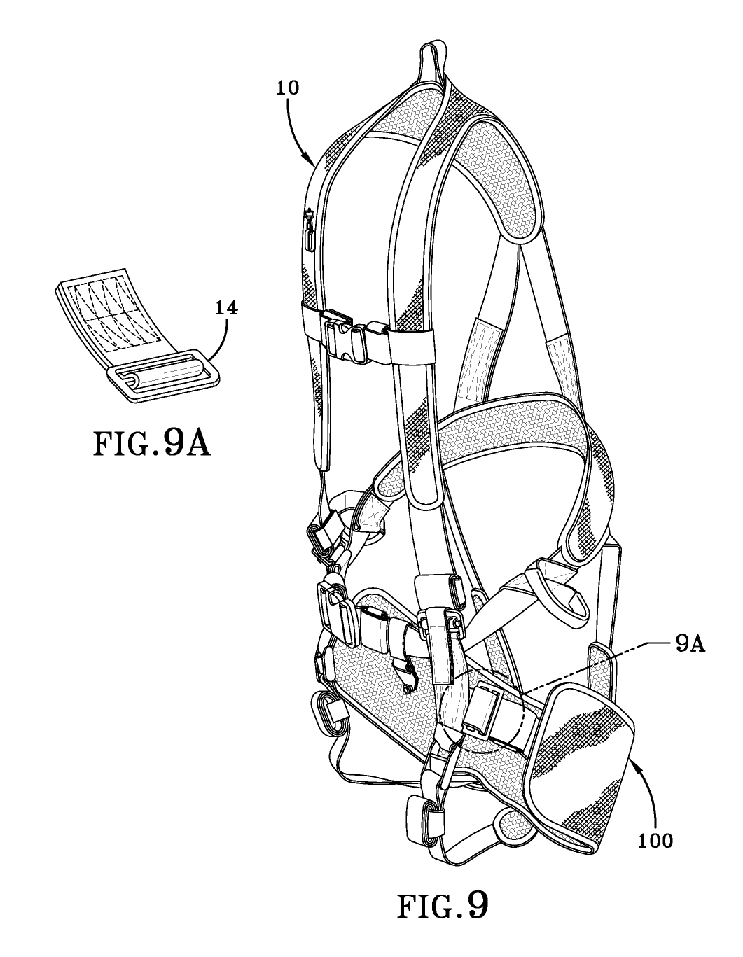

In this configuration, the adjuster buckle 14 has a length of strap, webbing or rope material permanently attached to one side of the adjuster buckle with enough length to allow the adjuster buckle to be attached to any conventional harness securely and must be of the appropriate weight bearing capacity. See FIGS. 9 and 9A. The end of the length of strap, webbing or rope material is affixed to the other side of the adjuster buckle 14 in such a way to provide for adjustability while providing the final adjustment to be fixed in place until the user needs to readjust the length.

The Suspension Relief Seat 100 may be attached to any Conventional harness 10 by threading the end of the length of strap, webbing or rope material through an adjuster buckle which is permanently attached to the Conventional harness at the appropriate place on the bottom of the shoulder strap or the top of the leg strap of any conventional harness.

The stitch pattern 30 which attaches the Adjuster buckle 14 permanently to the Conventional harness must be one that ensures sufficient strength to avoid breakage in deployment; and not sewn in such a way that one end of the strap, webbing or rope material being sewn together is “torn” away from the other end of the strap, webbing or rope material placing all of the load on the stitches themselves.

The stitch pattern which attaches must be sewn in a manner such that the stitch pattern itself “STRENGTHENS” the weight bearing strap, webbing or rope material.

The position the SRS is sewn onto other commercially available harnesses may be along the shoulder strap above or below or at the waist area of the harness. It may also be sewn along the top of the leg strap if the harness configuration requires that in order to RENDER THE USER IN A SEATED POSITION LIKENED UNTO SITTING IN A PLAYGROUND SWING in the event of a fall or deployment as shown in FIG. 1.

In another embodiment, the Suspension Relief Seat may be attached via a combination of strap, webbing or rope material of the appropriate weight bearing capacity coupled with an adjuster buckle or buckle as dictated by the harness in order to accomplish: the weight bearing capacity and/or breaking strength; Comfort of wearing in normal use; RENDER THE USER IN A SEATED POSITION LIKENED UNTO SITTING IN A PLAYGROUND SWING in the event of a fall or deployment as shown in FIG. 1.

THE Suspension Relief Seat has two openings to allow the leg straps of the harness to be “laced” through the Suspension Relief Seat at the appropriate angle and then end of leg straps are reattached to the harness. This act of lacing creates a weave the way in which it laces through the seat of the Suspension Relief Seat. This helps maintain the positioning of the Suspension Relief Seat on the user. This act of “threading” the leg straps through the SRS in installation of the SRS creates a “woven” pattern of sorts which strengthens the overall harness system in the event of a fall.

The SUSPENSION RELIEF SEAT (SRS) itself is a weight/load bearing material with a wide enough surface area to accommodate a user sitting on it comfortably without putting stress on circulation (LIKENED UNTO SITTING ON A PLAYGROUND SWING).

2—The material making up the SRS may be a wide length of strap, webbing or rope material (2.5″ to 8″+ in width) or may be made up of a combination of several widths of more narrow strap, webbing or rope material of appropriate weight bearing capacity.

The material making up the SRS may be covered in another material for comfort and or aesthetics (camouflage; safety orange, etc.).

It accommodates maneuverability to an extent to reposition oneself on the SRS. This is important in the event a user cannot self-extract safely and must stay seated for a prolonged period of time while awaiting assistance.

THE SRS provides for adjustability for comfort while in normal use and/or in the event of a deployed situation.

The SUSPENSION RELIEF SEAT provides LIFE SAVING POTENTIAL: if a user falls in a harness, the user would be rendered in a seated position.

THE SRS provides a seated position taking the pressure off of the femoral artery in the legs which is typical of standard harnesses without the SRS technology. This provides lifesaving potential.

With the appropriate configured harness, leg straps may be loosened once the user is seated in the SRS.

The suspension relief seat may be added to any harness in several different ways, some of which are sewn onto the shoulder strap at a specific location on the shoulder strap to render the desired position when deployed such that the SUSPENSION RELIEF SEAT (SRS) strap, webbing or rope material become like a continuation of the shoulder straps like a “playground swing”.

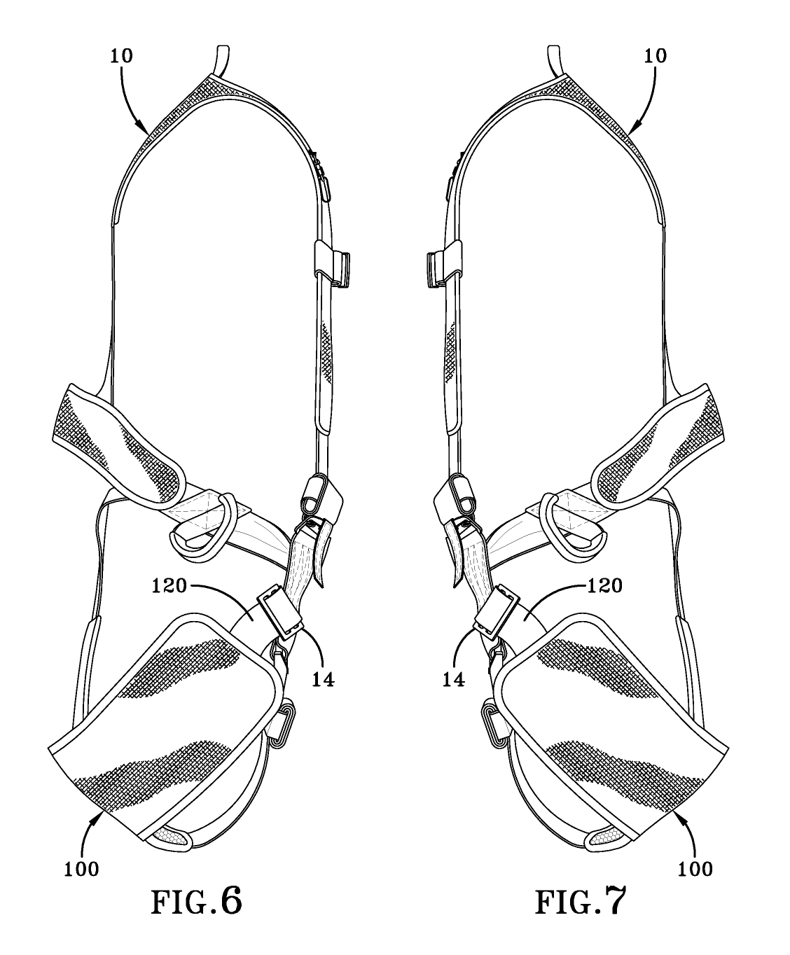

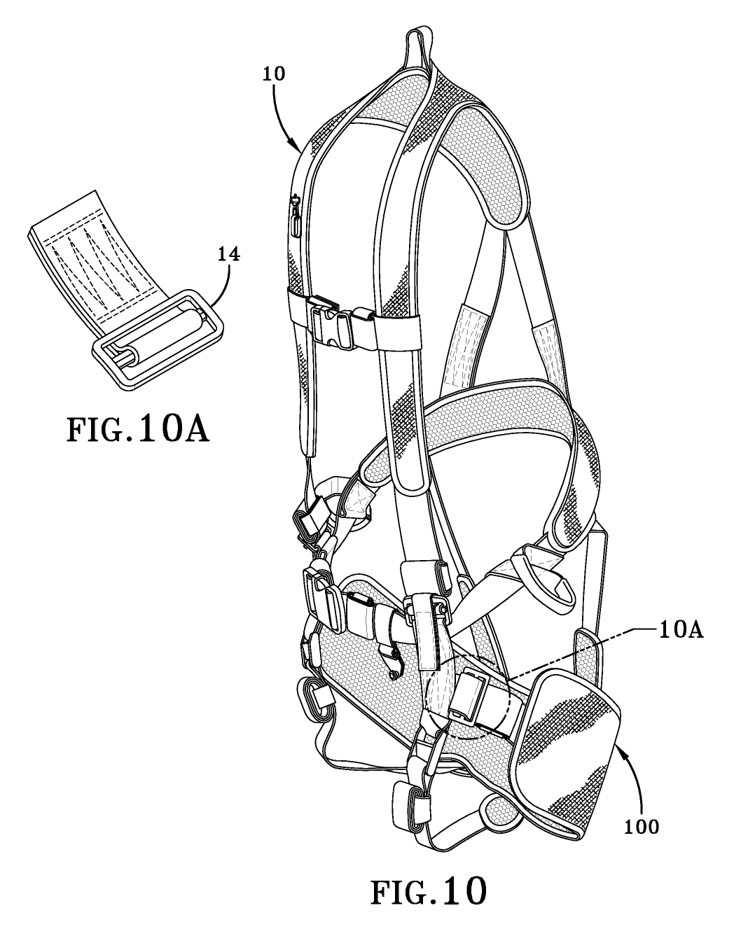

The SRS is still adjustable utilizing the weight bearing adjuster/buckle 14 on the SRS strap, webbing or rope shown in FIGS. 6-10A.

The stitch pattern must be one that ensures sufficient strength to avoid breakage in deployment; and not sewn in such a way that one end of the strap, webbing or rope material being sewn together is “torn” away from the other end of the strap, webbing or rope material placing all of the load on the stitches themselves.

Rather it must be sewn in a manner such that the stitch pattern itself “STRENGTHENS” the weight bearing strap, webbing or rope material.

The position the SRS is sewn onto other commercially available harnesses may be along the shoulder strap above or below or at the waist area of the harness. It may also be sewn along the top of the leg strap if the harness configuration requires that in order to RENDER THE USER IN A SEATED POSITION LIKENED UNTO SITTING IN A PLAYGROUND SWING in the event of a fall or deployment as shown in FIG. 1.

attached via a combination of strap, webbing or rope material of the appropriate weight bearing capacity coupled with an adjuster buckle or buckle 14, shown in FIGS. 6-10, as dictated by the harness in order to accomplish: the weight bearing capacity and/or breaking strength; Comfort of wearing in normal use; RENDER THE USER IN A SEATED POSITION LIKENED UNTO SITTING IN A PLAYGROUND SWING in the event of a fall or deployment as shown in FIG. 1.

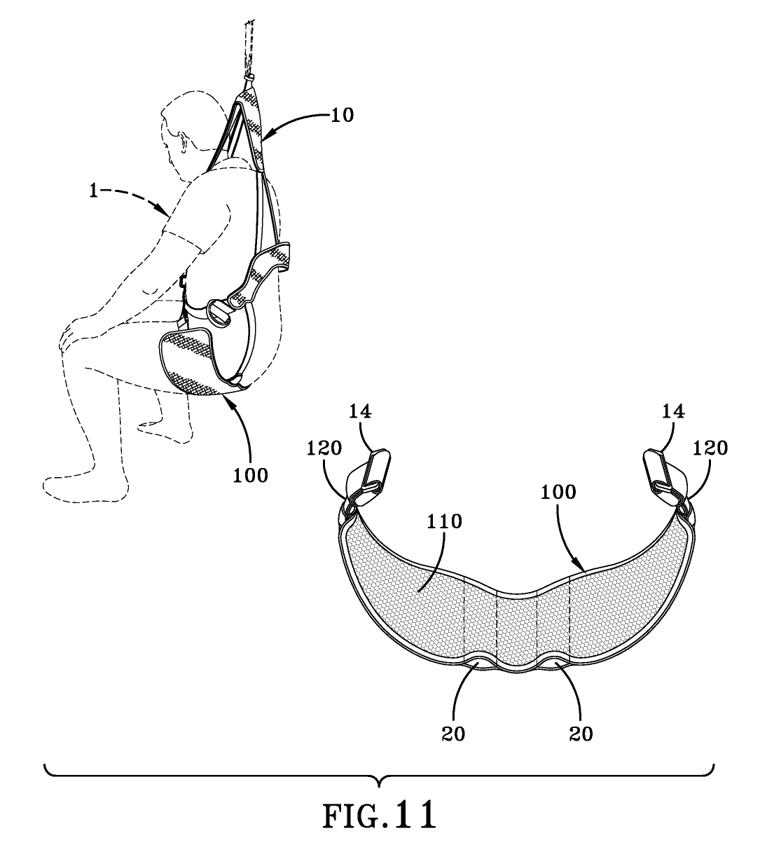

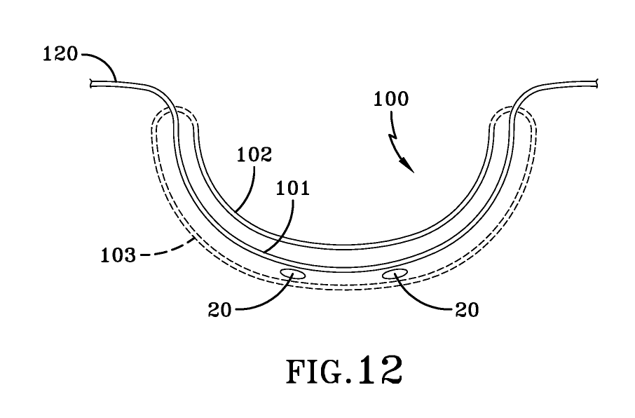

THE SRS provides for the leg straps of the harness to “thread” through the SRS 100 through openings 20 at the appropriate angle to yield greater weight/load bearing than would be in place without the SRS, as shown in FIGS. 11 and 12. This act of “threading” the leg straps through the SRS 100 in installation of the SRS creates a “woven” pattern of sorts which strengthens the overall harness system in the event of a fall.

The foregoing is provided for purposes of illustrating, explaining, and describing embodiments of this invention. Modifications and adaptations to these embodiments will be apparent to those skilled in the art and may be made without departing from the scope or spirit of this invention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A suspension relief seat for attachment to a safety harness comprises:
a suspension relief seat configured to lay across a backside of a user at or about the bottom of a buttock from one side of a hp to the other side of a hip when attached to a safety harness, the suspension relief seat provides for the transfer of body weight during a fall from leg straps of the harness and onto the suspension relief seat while avoiding the body weight being on the leg straps which presents a life threatening situation whereas when the user's body weight is shifted onto the suspension relief seat, avoids this life threatening situation.

2. The suspension relief seat for attachment to a safety harness of claim 1 wherein the suspension relief seat provides lifesaving potential if a user experiences a fall while wearing a safety harness which has incorporated the suspension relief seat, the user is automatically rendered in a seated position.

3. The suspension relief seat for attachment to a safety harness of claim 2 wherein the suspension relief seat renders the user in a seated position which avoids putting pressure on the femoral artery in the legs which is typical of conventional safety or support harnesses this allows the user maneuverability and comfort while waiting for assistance.

4. The suspension relief seat for attachment to a safety harness of claim 1 wherein the suspension relief seat when attached to the harness allows leg straps of the harness to be loosened once the user is seated in the suspension relief seat and body weight is completely transferred onto the suspension relief seat with no weight placed on the leg straps.

5. The suspension relief seat for attachment to a safety harness of claim 1 wherein the suspension relief seat (SRS) is made up of 3 or more layers of material with the inside layer being the layer which may be attached to each side of any conventional support harness and is a weight or load bearing material.

6. The suspension relief seat for attachment to a safety harness of claim 5 wherein the finished width of the inside material creates an area with wide enough surface area to accommodate a user sitting on it comfortably without putting stress on circulation.

7. The suspension relief seat for attachment to a safety harness of claim 6 wherein the material making up the SRS may be comprised of one width of a length of strap, webbing or rope material (2.5″ to 36″+ in width) or may be made up of a combination of several widths of narrow strap, webbing or rope material of appropriate weight bearing capacity configured or joined together in a way to create a width of 2.5″ to 24″+.

8. The suspension relief seat for attachment to a safety harness of claim 1 wherein the length of the seat area which may be 6″ to 48″ or more inches is configured to be wide enough to comfortably lay across the backside of the user at or about the bottom of buttocks from one side of hips to the other side of hips and is reduced down to a more narrow length of strap, webbing or rope material which can be threaded through an adjuster buckle.

9. The suspension relief seat for attachment to a safety harness of claim 5 wherein the material making up the SRS may have an outer layer in another material for comfort.

10. The suspension relief seat for attachment to a safety harness of claim 5 wherein the material making up the SRS may have a third layer for aesthetics.

11. The suspension relief seat for attachment to a safety harness of claim 10 wherein the material making up the SRS may have a fourth layer which may be utilized to create storage pockets or pouches which can be of varying widths and depths.

12. The suspension relief seat for attachment to a safety harness of claim 1 wherein the width of the SRS when in use accommodates comfort and maneuverability in such a way to allow the user to reposition on the SRS in the event a user cannot self-extract safely and must stay seated for a prolonged period of time while awaiting assistance.

13. The suspension relief seat for attachment to a safety harness of claim 1 wherein the SRS is adjustable for comfort while in normal use or in the event of a deployed situation.

14. The suspension relief seat for attachment to a safety harness of claim 1 wherein the suspension relief seat may be added to any safety harness in several different ways, including being sewn onto the shoulder strap at a specific location on the shoulder strap to render the desired position when deployed such that the suspension relief seat (SRS) strap, webbing or rope material become like a continuation of the shoulder straps like a “playground swing”.

15. The suspension relief seat for attachment to a safety harness of claim 1 wherein the suspension relief seat may be sewn into the bottom of the shoulder strap of a conventional harness in such a way to allow the length of strap, webbing or rope material (2.5″ to 24″+ in width) to be adjusted to fit properly to the user once the harness is donned. In this configuration, the length of strap, webbing or rope material (2.5″ to 24″+ in width) may be threaded through a weight bearing adjuster buckle which provides a high-test breaking strength and adjustability.

16. The suspension relief seat for attachment to a safety harness of claim 15 wherein the adjuster buckle has a length of strap, webbing or rope material permanently attached to one side of the adjuster buckle with enough length to allow the adjuster buckle to be attached to any conventional harness securely and must be of the appropriate weight bearing capacity and wherein an end of the length of strap, webbing or rope material is affixed to the other side of the adjuster buckle in such a way to provide for adjustability while providing the final adjustment to be fixed in place until the user needs to readjust the length.

17. The suspension relief seat for attachment to a safety harness of claim 1 wherein the suspension relief seat is attached to any conventional harness by threading the end of the length of strap, webbing or rope material through an adjuster buckle which is permanently attached to the conventional harness at the appropriate place on the bottom of the shoulder strap or the top of the leg strap of any conventional harness.

18. The suspension relief seat for attachment to a safety harness of claim 17 wherein the stitch pattern which attaches the adjuster buckle permanently to the conventional harness must be one that ensures sufficient strength to avoid breakage in deployment; and not sewn in such a way that one end of the strap, webbing or rope material being sewn together is “torn” away from the other end of the strap, webbing or rope material placing all of the load on the stitches themselves.

19. The suspension relief seat for attachment to a safety harness of claim 18 wherein the stitch pattern which attaches the adjuster buckle to the harness must be sewn in a manner such that the stitch pattern itself “strengthens” the weight bearing capacity of the strap, webbing or rope material.

20. The suspension relief seat for attachment to a safety harness of claim 1 wherein the position the SRS is sewn onto other commercially available harnesses may be along the shoulder strap above or below or at the waist area of the harness or sewn along the top of the leg strap if the required by the harness configuration in order to render the user in a seated position likened unto sitting in a playground swing in the event of a fall or deployment.

21. The suspension relief seat for attachment to a safety harness of claim 1 wherein the suspension relief seat may be attached via a combination of strap, webbing or rope material of the appropriate weight bearing capacity coupled with an adjuster buckle or buckle as dictated by the harness in order to accomplish; 1—the weight bearing capacity and/or breaking strength; 2—comfort of wearing in normal use; and 3—render the user in a seated position likened unto sitting in a playground swing in the event of a fall or deployment.

22. The suspension relief seat for attachment to a safety harness of claim 1 wherein the suspension relief seat has two openings to allow the leg straps of the harness to be “laced” through the suspension relief seat at the appropriate angle and then end of leg straps are reattached to the harness, this act of lacing creates a weave the way in which it laces through the seat of the suspension relief seat, and helps maintain the positioning of the suspension relief seat on the user, the “threading” the leg straps through the SRS in installation of the SRS creates a “woven” pattern of sorts which strengthens the overall harness system in the event of a fall.
